(19) United States
(12) Patent Application Publication
(10) Pub. No.: US 2019/0073704 A1
(43) Pub. Date: Mar. 7, 2019

(54) SYSTEM AND METHOD FOR GROUP PURCHASING

(71) Applicant: Gustavo Neiva de Medeiros, (US)

(72) Inventor: Gustavo Neiva de Medeiros, New York, NY (US)

(21) Appl. No.: 16/122,602

(22) Filed: Sep. 5, 2018

Related U.S. Application Data
(60) Provisional application No. 62/555,463, filed on Sep. 7, 2017.

(51) Int. Cl. G06Q 30/02; G06Q 30/06; G06F 9/54; G06F 17/30

(52) U.S. Cl. CPC G06Q 30/0283; G06F 17/30861; G06F 9/54; G06Q 30/0641

(57) ABSTRACT

A system and method perform group purchasing. Specifically, sellers offer goods or services for sale on the system and users can agree to purchase and share their purchase with others. The price displayed is reduced as more users agree to purchase. Each user is charged the same final price. Thus, some of the purchasing and selling power is put back in the hands of the content-providing studios and end consumers. The system includes a processor for receiving a purchase order for an item from each of a plurality of users, wherein an initial price for the item is reduced to a reduced price in relation to the number of users purchasing the item; and a fulfillment system for receiving payment from the plurality of users at the reduced price per user and for delivering the item to the plurality of users.

### CROSS-REFERENCE TO RELATED APPLICATION

This application claims priority to U.S. Provisional Application No. 62/555,463, filed on Sep. 7, 2017, which is incorporated by reference in its entirety.

### FIELD OF THE INVENTION

In general, the present invention relates to systems and methods for group purchasing. More specifically, the present disclosure is related to an automated system and method for electronically renting or purchasing goods and services at discounted group rates.

### BACKGROUND

A group purchasing organization (GPO) is an entity that is created to leverage the purchasing power of a group of businesses to obtain discounts from vendors based on the collective buying power of the GPO members. These arrangements provide the seller with the certainty of a large quantity of orders in exchange for a discounted price for the buyer. GPOs have been widely used in the United States and abroad. GPOs exist in industries such as healthcare, food service, grocery, industrial manufacturing, electrical and non-profits. As such, GPOs have been in existence for physical goods and mostly for the benefit of business.

For various media, in the past, friends could “chip in” to buy a DVD, a CD or a book together to pay less than each friend purchasing each item on his own. Each friend could then either share the item after each individual uses the item, or watch or listen to the item together. However, this is difficult to do with online content because each item is not tangible and not transferable.

Thus, online retailers for digital media such as APPLE™, HULU™, and AMAZON™ took away the possibility for customers to conveniently purchase media, e.g., a movie, together and have gained the upper hand in the value chain. With digital content, however, the inability to sell the product to everyone willing to pay not only leaves profits unrealized but also incentivizes piracy as those who are willing to pay less than full price look for other means of obtaining the content.

For this reason, although not common, GPOs can be particularly valuable with creative digital content. The projected revenue for a creative work such as a movie, song, or book is highly unpredictable. However, the marginal cost of production is negligible, especially if delivered digitally. Access to a digital file has virtually no marginal extra production costs or marginal distribution costs. So, the cost of producing and delivering one additional digital copy is minimal. Due to the nature of the items sold, discounts can be more readily obtained. The seller can maximize profits by selling to everyone willing to pay at least one penny.

However, the major drawback to such arrangements is transaction costs. These arrangements must be negotiated between sellers and buyers. Buyers must find a way to act collectively. Sellers must be able to enforce agreements. This is a costly process, which is why it is usually not undertaken.

Another disadvantage of existing systems and methods is that sellers cannot know how much demand exists with certainty before the sale. Therefore, pricing involves a good deal of guesswork. Sellers could price products high and reduce the price if demand is insufficient, or sellers could price low and increase the price if demand is high. Both methods require time and marketing and can cause customers who paid a higher price to feel ill-will towards the company.

Therefore, a need exists for a system and method to enable group purchasing that minimizes transaction costs.

### SUMMARY OF THE INVENTION

The present invention is a system and method for group purchasing. Specifically, sellers offer goods or services for sale on the system and users can agree to purchase and share their purchase with others. The price displayed is reduced as more users agree to purchase. Each user is charged the same final price. Thus, the present invention puts back some of the purchasing and selling power in the hands of the content-providing studios and end consumers.

In one embodiment, the present invention includes a system comprising: a processor for receiving a purchase order for an item from each of a plurality of users, wherein an initial price for the item is reduced to a reduced price in relation to the number of users purchasing the item; and a fulfillment system for receiving payment from the plurality of users at the reduced price per user and for delivering the item to the plurality of users. The initial price is reduced to the reduced price when a target number of users have purchased the item. The prices are reduced by a fixed amount or by a variable amount. The system further comprises a display; wherein the processor displays the initial price on the display to a first user; and wherein the first user invites the plurality of users to purchase the item. The processor executes an application program interface (API) to control the display. The display displays a website with the initial price displayed therein. A mobile device has the display and associated with the first user; and wherein the mobile device operates an app for displaying the initial price on the display.

In another embodiment, the present invention includes a method comprising: receiving a purchase order for an item at a processor from each of a plurality of users; reducing an initial price for the item to a reduced price in relation to the number of users purchasing the item; receiving payment from the plurality of users at the reduced price per user; and delivering the item to the plurality of users using a fulfillment system. The method further comprises attaining a target number of users who have purchased the item; and wherein the initial price is reduced to the reduced price when the target number of users have purchased the item. The prices are reduced by a fixed amount or by a variable amount. The method includes displaying the initial price on a display to a first user; and inviting, by the first user, the plurality of users to purchase the item. The method includes executing an application program interface (API) by the processor to control the display. The display displays a website with the initial price displayed therein. The method includes communicating with the processor using a mobile device having the display and associated with the first user; and operating an app on the mobile device for displaying the initial price on the display.

In a further embodiment, the present invention includes a method comprising: displaying an initial price for an item of content to a first user; giving the first user the choice to invite a plurality of users to share the item of content and to share a final price of the item of content; receiving a purchase order for the item of content at a processor from each of the plurality of users; reducing the initial price for the item to a reduced price in relation to the number of users purchasing the item; receiving payment from the plurality of users at the reduced price per user; and delivering the item of content to the plurality of users using a fulfillment system. The method includes executing an application program interface (API) using the processor. The method also includes monitoring a current price of the item of content using the API; monitoring the number of users purchasing the item of content using the API; and reducing the current price to the reduced price using the API. The method also includes interacting with a database of content using the API; and controlling the access to the item of content by the plurality of users using the database.

### BRIEF DESCRIPTION OF THE SEVERAL VIEWS OF DRAWINGS

The foregoing summary, as well as the following detailed description of presently preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a diagram showing a general overview of a system of the present invention.

FIG. 2 is a diagram showing various code modules uses in the processor of the present invention.

FIG. 3 is a diagram showing the system of the present invention in greater detail.

FIG. 4 is a flowchart showing the steps for the method of the present invention.

FIG. 5 is a flowchart showing pricing of a product or service using the system and method of the present invention.

FIG. 6 is a flowchart showing an example pricing of a rental of content using the system and method of the present invention.

To facilitate an understanding of the invention, identical reference numerals have been used, when appropriate, to designate the same or similar elements that are common to the figures. Further, unless stated otherwise, the features shown in the figures are not drawn to scale, but are shown for illustrative purposes only.

### DETAILED DESCRIPTION OF THE INVENTION

Certain terminology is used in the following description for convenience only and is not limiting. The article “a” is intended to include one or more items, and where only one item is intended the term “one” or similar language is used. Additionally, to assist in the description of the present invention, words such as top, bottom, side, upper, lower, front, rear, inner, outer, right and left are used to describe the accompanying figures. The terminology includes the words above specifically mentioned, derivatives thereof, and words of similar import.

The present invention is a system and method for group purchasing. Specifically, sellers offer goods or services for sale on the system and users can agree to purchase and share their purchase with others. The price displayed is reduced as more users agree to purchase and each user is charged the same final price.

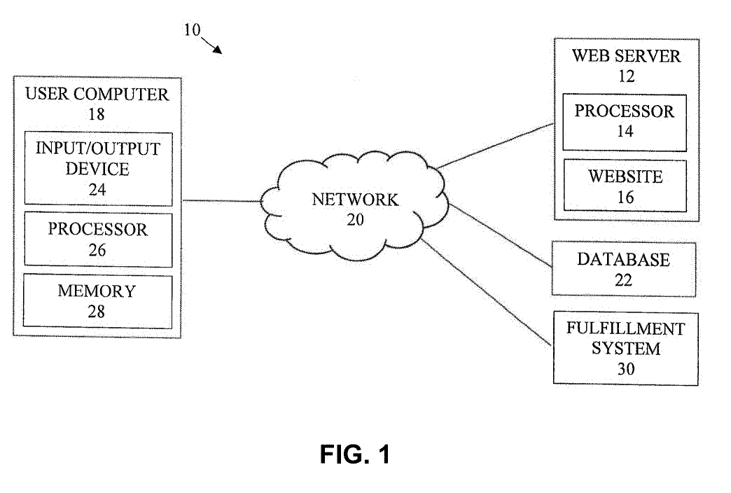

Referring to FIG. 1, the present invention connects consumers and providers using the system 10, so that the consumer selects an item to rent or own, and the provider provides the item selected by the consumer. The system 10 and method of the present invention are implemented by a web server 12 which includes a processor 14 for operating a website 16 for hosting a marketplace or seller webpage in which products and their prices are displayed. The seller may be an individual posting a product for sale, or a professional vendor displaying an inventory of available products. The web server 12 is accessible by multiple users, with each user, as a consumer or customer, using a respective user computer 18 communicating through a network 20, such as the Internet and/or other communication interfaces, to the web server 12. The web server 12 also accesses a database 22 of seller information, including data on the seller products, through the network 20. In an alternative embodiment, the web server 12 includes the database 22.

The user computer 18 includes an input/output device 24, such as a display, a keyboard, and/or a mouse for displaying and interacting with a graphic user interface (GUI) displaying a web page of the website 16. The user computer 18 also includes a processor 26 and a memory 28 for implementing and interacting with the GUI displayed on the input/output device 24 to view and select products in the website.

By implementing the product-based website, the system 10 and method of the present invention allow users to purchase products or services, which are delivered by merchant services, such as a fulfillment system 30 known in the art. The fulfillment system 30 may be any known system for fulfilling or otherwise delivering a product, such as AMAZON.COM™ or other electronic commerce (E-commerce) and merchant systems. As described herein, the term “product” is understood to be any purchasable item, content, goods, and/or a service which can be delivered, rented, implemented, granted easement, easement in gross, given rights to, transferred, conveyed, assigned, endorsed and/or otherwise fulfilled, booked, reserved, and claimed by any merchant services such as the fulfillment system 30. Some examples include but are not limited to media, assets, instruments, real estate, rental units, reservations, accommodations, fares, events, tangibles, intangibles, digital items, memberships, subscriptions, titles, deeds, insurance, etc.

The platform provided by the system 10 gives users the ability to form a group for purposes of jointly renting or purchasing a product. Users need not negotiate with each other or the seller. Since every additional user reduces the price and all users pay the final price, there is an incentive for users to recruit more users to join the group purchase. The platform offered by the system 10 also allows the seller to price products based on sales volume in order to maximize profits.

As mentioned above, with digital products, discounts can be more readily obtained. The access to a digital file has virtually no marginal production or distribution cost. Therefore, the spot price equilibrium between wholesalers, retailers, and consumers has a much higher velocity. As the system 10 of the present invention is an intermediary platform, the system 10 does not directly control the prices. Instead, purchasing and selling power rests primarily in the hands of producers, such as content providers, and end consumers.

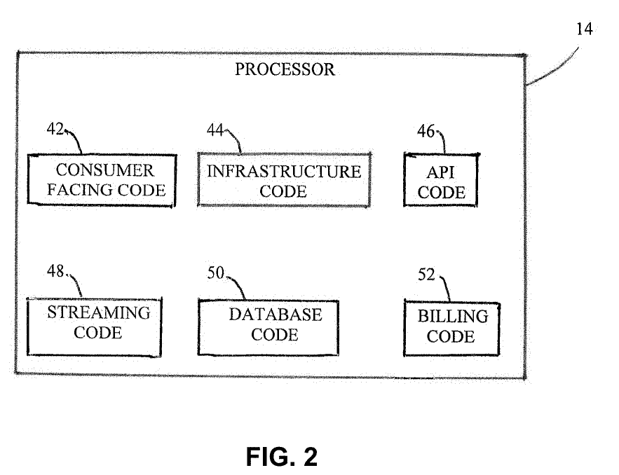

Referring to FIG. 2, in the exemplar embodiment of a digital content rental system, the system 10 has the processor 14 including and/or executing various software code modules such as consumer facing code 42, infrastructure code 44, application programming interface (API) code 46, streaming code 48, database code 50, and/or billing code 52. Each of these software modules 42-52 may be written in Javascript, or in other known programming languages such as C++, C#, or .NET. The consumer facing code 42 can be software implementing the website 16, or a web app, a mobile app for a mobile device, a smart TV, or an Internet streaming device that allows the consumer to interact with the system 10. The consumer facing code 42 may be GRU-based, and may include frontend code or backend code, with the frontend code supporting the website 16, web apps, ROKU™ services, smart TV services, AMAZON™ FIRESTICK™ services, a SONY™ PLAYSTATION™, APPLETV™ services, a mobile-based APPLE™ iOS™, a tablet-based APPLE™ iOS™, a mobile-based GOOGLE™ ANDROID™, and a tablet-based GOOGLE™ ANDROID™, or any other known content providing service or platform. The frontend code and/or the backend code may be stored on AMAZON™ AWS ELASTIC BEANSTALK™-based code-storing services or other known code repositories.

The infrastructure code 44 manages all of the physical and virtual servers that host content, including remote application servers. The API code 46 interfaces between different applications. The streaming code 48 delivers the content from the servers to the consumers. The streaming code 48 may include custom WOWZA™ streaming service modules or similar transcoding software, and may also be on a remote application server. The database code 50 implements and controls the database 22, and may be a MYSQL database service or other known database services. The database code 50 may implement or use CHEDDARGETTER™ or other payment processing services linked to a Digital Rights Management (DRM) decision engine, which is in turn linked to the MYSQL database service or other known database services. The billing code 52 manages a payment processor, and so may interact with the fulfillment system 30 to process payments and bill for the products, services, or content being delivered by the system 10 to the consumer using the user computer 18.

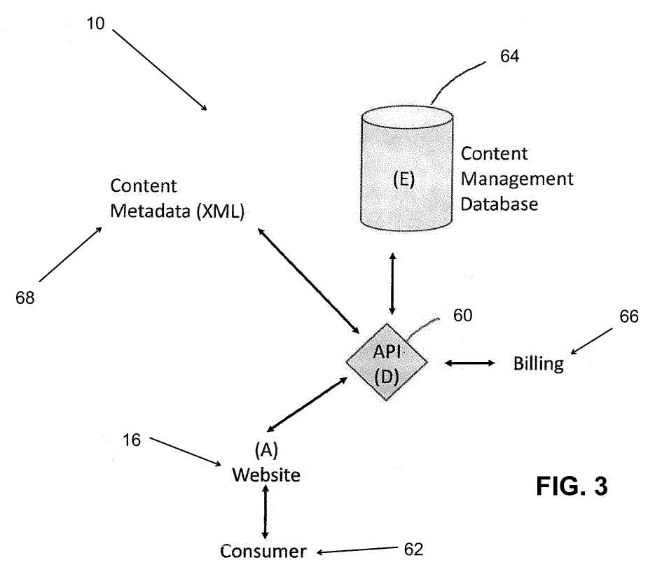

In particular, the API code 46, which can be publicly available, allows the frontend to receive the content and support all the available services. The API code 46 can be used in interfaces, an administrative portal, or client apps and services. Using the API code 46, all services are supported, and the API code 46 may be stored on AMAZON™ AWS ELASTIC BEANSTALK™-based code-storing services or other known code repositories. Referring to the system 10 shown in greater detail in FIG. 3, the API code 46, implementing an API 60, interacts with the frontend in the form of the website 16 accessed by a consumer 62 using the user computer 18 in FIG. 1. The database 22, such as a content management database 64 in FIG. 3, holds the data of the system 10, and the API 60, implemented by the API code 46, can access the database 64 to retrieve content. The API 60 also performs billing services 66 to bill consumers 62 for the delivered product, such as content from the content management database 64, using the fulfillment system 30 having a payment processor or other merchant services. The API code 46, implementing the API 60, can also access content metadata 68 stored in the processor 14 and/or in the database 22 to facilitate services such as searching for products, content, or other items and services described herein.

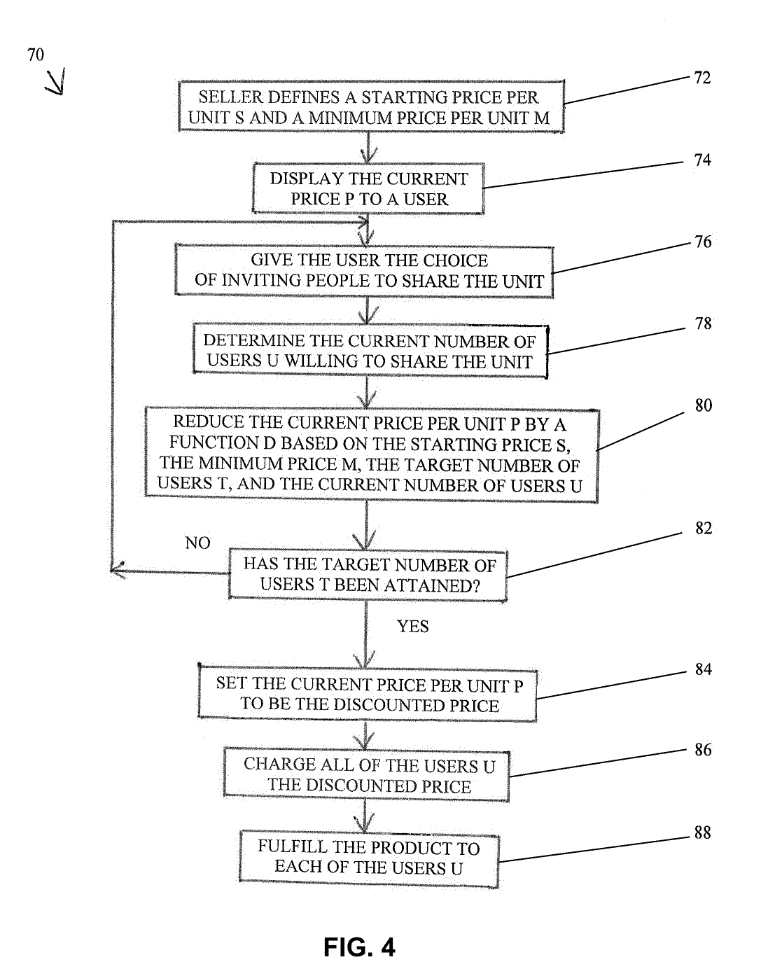

Referring to FIG. 4, in a method of the present invention, the processor 14 operates the API code 46 to generate the API 60 to perform an API algorithm, as described herein, which intelligently reduces the price of a product based on the number of consumers who commit to purchasing the product. The API 60, operating the API algorithm, communicates with billing software 52 for performing billing services 66, and with the content databases 64 to perform content management, searching, and delivery. Using the API algorithm, the method 70 starts with the seller defining a starting price per unit S and a minimum price per unit M that the seller is willing to accept if a target number of users T is reached in step 72. The method then displays the current price P to a user, for example, through the website 16 and/or via an app in step 74. The website 16 or app may receive a purchase order from the user in the form of a filled-in form on the website 16 or app, or other known methods of submitting a purchase order, such as them electronic messages such as E-mails, text messages, tweets on TWITTER™, or other known electronic messaging techniques.

The user is then given the choice of inviting people in step 76 to share the unit, such as a product or content; for example, rental of a movie. The user may invite other people by sending them electronic messages such as E-mails, text messages, tweets on TWITTER™, or other known electronic messaging techniques. The method then determines the current number of users U willing to share the unit in step 78; for example, as indicated by the number of purchase orders from the users U. The price per unit P is reduced by a function D, in step 80, with the function D being based on the starting price S, the minimum price M, the target number of users T, and the number of users U.

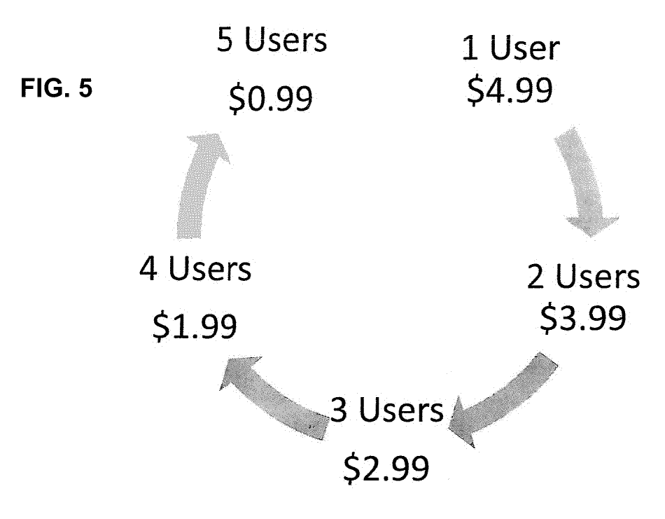

The function D produces a price P equal to the starting price S when the number of users U is 1. The function D produces a price P that is equal to or less than the starting price S and is inversely proportional to the number of users U. For example, the function D may decrement the price linearly by a fixed amount, such as $0.01 per user U, or $1.00 per user U as shown in FIG. 5 and described herein. Alternatively, the function D may be non-linear, and so may decrement the prices by unequal and/or variable amounts, such as $0.01 per user for the first hundred users, $0.02 per user for the second hundred users, etc. When the number of users U is greater than or equal to the target number of users T, the price P is equal to the minimum price M. The total revenue P×U increases as U increases. The method determines in step 82 if the target number of users T has been attained. If not, the method loops back to step 76 to prompt the user to invite more people to share the unit. However, if the target number of users T has been attained in step 82, the method proceeds to step 84 to set the current price per unit P to be the discounted price, and all of the users U are charged or billed the discounted price in step 86, for example, by a payment processor which may be part of the fulfillment system 30. The fulfillment system 30 then fulfills the product to each of the users U in step 88 who have been charged or billed; for example, by distributing the product to one user at a time, or by distributing multiple products to each user, such as allowing each user access to a rental movie at the discounted price.

In an alternative embodiment, the seller could fix the price P for each user based on the number of users U instead of basing the final price for each user on the function D. The seller could also fix the minimum and maximum number of users. That is, the seller could display to consumers in advance that the product or service will not be sold unless a minimum number of users are purchasing. Similarly, the seller could display to consumers how many users are permitted in a particular group of purchasers.

Moreover, various different functions D are possible and even multiple functions may be used for the same sale depending on variables such as the number of users, the time remaining in the offer for sale, and the type of sale.

Delivery of the product can be contemporaneous, i.e., delivered during the sale. The product is delivered immediately after a user agrees to purchase. Users can be charged immediately and then issued a refund at the end of the sale period if the final price falls below what a user has been charged. Otherwise, the users can be charged at the end of the sale, or have funds withheld until the end of the sale at which time only the final price will be charged.

Delivery can also be concurrent, i.e., delivered to all participating users upon hitting a target. When a predetermined number of users, price, or total revenue is achieved, all users are charged the price and the product is delivered to all users who agreed to purchase at that price.

Delivery can also be simultaneous, i.e., delivered to all participating users at a time certain. At a time certain, all users are charged the final price and the product is delivered to all users simultaneously. This can be useful, for example, for the purchase of tickets to live events.

In an alternative embodiment, the seller can set a fixed total revenue P×U. This would enable small groups renting a movie or collection of music to watch or listen as a group and to split the cost of the rental. Various safeguards can be used to ensure that the feature is not abused. For example, all members of the group would have to be in the same physical location as measured by GPS, Wi-Fi connection, or other means. Other restrictions can be created to reduce the value of collective rental over multiple individual rentals. For example, the movie can only be used on one device at a time. Such restrictions can also be used for digital books or even physical products. For example, a group can purchase a single lawnmower to share among themselves. Sharing can be facilitated by a check-out/check-in system.

Whenever the number of users U increases, the function D is performed for one or more additional users to produce a price that would be paid by all if additional users agree to purchase. This potential price and the number of additional users required to achieve that price is displayed to all users. In this embodiment, the seller displays the options to the consumer in advance. However, in other embodiments, the seller could keep the options hidden until the user(s) enter requested information, e.g., number of purchasers.

Other filters could be implemented. For example, the seller could require the purchaser to enter contact information, and the seller can decline the purchase based on the contact information. An example of this denial of a purchase could be commercial establishments being barred from purchasing streaming movies or sports events.

Referring to FIG. 5, in one illustrative example, a first user agrees to rent content for $4.99. If a second user agrees to rent the content for $3.99, both users receive the same discounted $3.99 price. The provider would realize total revenue of $7.98, which is more than if only the first user had rented at $4.99. If a third user agrees to rent at $2.99, the provider's total revenue would be $8.97. For four users, total revenue would be $7.96 and for five users it would be $4.95. Thus, a sale is realized due to the offered discount instead of a no sale because other users would not have been willing to purchase the content for $4.99.

In another embodiment, the provider could set pricing as: 1 user at $4.99; 2 users at $4.49 each; 3 users at $3.99 each; 4 users at $3.49 each; and 5 users at $2.99 each, and so on. Thus, the provider realizes a larger overall revenue with each additional user, even though the unit price is reduced.

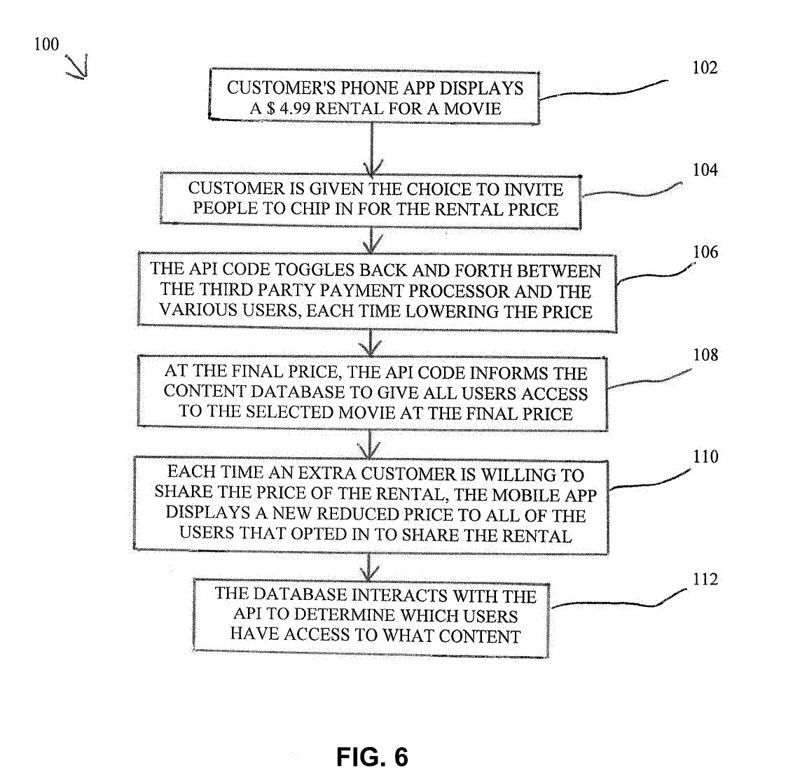

In an example operation, shown in FIG. 6, the method 100 has a consumer's phone app display $4.99 as the initial rental price, for example, for a movie in step 102, and offers the customer the ability to invite others to join a group rental, and so to chip in for the rental price in step 104. The API 60, implemented by the API code 46, toggles back and forth between the third party payment processor for billing 66 and the various users 62, in step 106. Each time a user is added, the price is lowered and recalculated, and the new price is displayed to all participating users in step 106. The API 60 also has an administrative function that allows the content owner to input products and product information, as well as to arbitrarily input a price discount per each additional user, such as shown in FIG. 5.

Upon final purchase by all users who opt in for the rental of the content, the API 60 informs the content database 64 that the users now have access to the content, such as the selected movie, at the final discounted price in step 108. In addition, each time an extra customer is willing to share the price of the rental, the mobile app will display a new reduced price in step 110 to all of the users that opted in to share the rental. The content database 64 functions as a gatekeeper and interacts with the API 60 to determine which users have access to what content in step 112. Only after the API 60 has confirmed that a specific user has paid his/her share of the purchase will the content database 64 grant the user access to the content.

One of ordinary skill in the art will recognize that the system and method of the present invention could be used with a variety of goods and services. For example, the present invention could be used by a group of purchasers to buy bulk goods. Final pricing for the goods would be determined by the final number of purchasers for those goods, and delivery of an equal proportion of the goods to each purchaser could be processed. In another example, lawn care services could be sold using the system and method of the present invention. For example, the seller could provide group discounts for lawn services for residents on the same street. In this way, the seller is able to schedule and complete multiple jobs at the same location on the same day, thereby reducing transportation costs. In yet another example, office cleaning services could be booked and purchased by several offices in the same building using the system and method of the present invention. As such, the seller is able to work in a more efficient manner.

The present invention may be embodied in other specific forms without departing from its spirit or essential characteristics. The described embodiments are to be considered in all respects only as illustrative and not restrictive. The scope of the invention will be, therefore, indicated by claims rather than by the foregoing description. All changes which come within the meaning and range of equivalency of the claims are to be embraced within their scope.

What is claimed is:

1. A system comprising:
a processor for receiving a purchase order for an item from each of a plurality of users, wherein an initial price for the item is reduced to a reduced price in relation to the number of users purchasing the item; and
a fulfillment system for receiving payment from the plurality of users at the reduced price per user and for delivering the item to the plurality of users.

2. The system of claim 1, wherein the initial price is reduced to the reduced price when a target number of users have purchased the item.

3. The system of claim 1, wherein the prices are reduced by a fixed amount.

4. The system of claim 1, wherein the prices are reduced by a variable amount.

5. The system of claim 1, further comprising a display;
wherein the processor displays the initial price on the display to a first user; and
wherein the first user invites the plurality of users to purchase the item.

6. The system of claim 5, wherein the processor executes an application program interface (API) to control the display.

7. The system of claim 5, wherein the display displays a website with the initial price displayed therein.

8. The system of claim 5, further comprising a mobile device having the display and associated with the first user; and
wherein the mobile device operates an app for displaying the initial price on the display.

9. A method comprising:
receiving a purchase order for an item at a processor from each of a plurality of users;
reducing an initial price for the item to a reduced price in relation to the number of users purchasing the item;
receiving payment from the plurality of users at the reduced price per user; and
delivering the item to the plurality of users using a fulfillment system.

10. The method of claim 9, further comprising:
attaining a target number of users who have purchased the item; and
wherein the initial price is reduced to the reduced price when the target number of users have purchased the item.

11. The method of claim 9, wherein the prices are reduced by a fixed amount.

12. The method of claim 9, wherein the prices are reduced by a variable amount.

13. The method of claim 9, further comprising:
displaying the initial price on a display to a first user; and
inviting, by the first user, the plurality of users to purchase the item.

14. The method of claim 13, further comprising:
executing an application program interface (API) by the processor to control the display.

15. The method of claim 13, wherein the display displays a website with the initial price displayed therein.

16. The method of claim 13, further comprising:
communicating with the processor using a mobile device having the display and associated with the first user; and
operating an app on the mobile device for displaying the initial price on the display.

17. A method comprising:
displaying an initial price for an item of content to a first user;
giving the first user the choice to invite a plurality of users to share the item of content and to share a final price of the item of content;
receiving a purchase order for the item of content at a processor from each of the plurality of users;
reducing the initial price for the item to a reduced price in relation to the number of users purchasing the item;
receiving payment from the plurality of users at the reduced price per user; and
delivering the item of content to the plurality of users using a fulfillment system.

18. The method of claim 17, further comprising:
executing an application program interface (API) using the processor.

19. The method of claim 18, further comprising:
monitoring a current price of the item of content using the API;
monitoring the number of users purchasing the item of content using the API; and
reducing the current price to the reduced price using the API.

20. The method of claim 18, further comprising:
interacting with a database of content using the API; and
controlling the access to the item of content by the plurality of users using the database.
